(19) United States
(12) Patent Application Publication
(10) Pub. No.: US 2025/0207528 A1
(43) Pub. Date: Jun. 26, 2025

(54) Hybrid Motor for Fluid Pump

(71) Applicant: Xylem Dewatering Solutions, Inc., Bridgeport, NJ (US)

(72) Inventors: Faizan Chowdhury, Bridgeport, NJ (US); Mike Ramos, Bridgeport, NJ (US); Ronald Orbin, Bridgeport, NJ (US); Miao Yan, Houston, TX (US); Nathan Neece, Collingswood, NJ (US)

(21) Appl. No.: 18/999,568

(22) Filed: Dec. 23, 2024

Related U.S. Application Data
(60) Provisional application No. 63/613,353, filed on Dec. 21, 2023.

(51) Int. Cl. F02B 63/06; F02B 63/04; F04B 17/03; F04B 17/05; F04B 17/06; F04D 13/02; F04D 13/06

(52) U.S. Cl. CPC F02B 63/06; F02B 63/042; F04B 17/03; F04B 17/05; F04B 17/06; F04D 13/021; F04D 13/068

(57) ABSTRACT

A hybrid motor for a fluid pump, including an engine having a flywheel and an engine housing; an electric motor having an electric motor housing; at least one storage battery coupled to the electric motor; a clutch rotatably connected to a shaft, the shaft extending from the flywheel through the electric motor; a controller configured to control the fluid pump with inputs from an operator and the fluid pump and an output of the engine and the electric motor; and an inverter coupled between the electric motor and the controller, the inverter providing at least a charging setting and a power setting; when the inverter is in the charging setting the electric motor produces power which is stored in the at least one electrical storage battery and when the inverter is in the power setting the electric motor is providing power as the output.

### BACKGROUND OF THE INVENTION

The present application claims priority to and the benefit of U.S. Provisional Application No. 63/613,353 filed Dec. 21, 2023, entitled “Hybrid Motor for Fluid Pump” the disclosure of which is hereby incorporated by reference in its entirety.

### FIELD OF THE INVENTION

The present invention relates to a hybrid motor having an electric motor and an engine for providing power to a fluid pump. More specifically, the hybrid motor is portable and includes a battery-operated electric motor and an internal combustion engine with an elastomeric coupler for connecting to a pump end.

### DESCRIPTION OF RELATED ART

As is generally known, hybrid motors use an internal combustion engine and a battery powered motor together. In other words, the hybrid motor combines and alternately uses torque of the internal combustion engine and torque of an electric motor.

In the pump arts, due to stringent regulations on emission control and a high cost associated with energy waste due to lightly loaded diesel engines, there is a need for a more energy efficient solution to achieve sustainable power production for portable pumps which often need to operate within a wide range of required site conditions. Common commercial non-hybrid pump systems do not operate at optimum efficiency. Therefore, there is a need for a hybrid system with a diesel engine that operates efficiently to charge the energy storage system in addition to driving any pumping mechanism.

It is an object of the invention to meet these needs and increase overall production efficiency by enabling a combustion engine and an electric motor to each operate in respective ranges of increased efficiency. Electric motors, for example, may be efficient at accelerating from a standing start, while combustion engines may be efficient during sustained periods of constant engine operation, such as in higher output settings. Having an electric motor to boost output in initial phases allows for improved efficiency.

### SUMMARY OF THE DISCLOSURE

The present disclosure generally relates to a hybrid motor for a fluid pump, including an engine having a flywheel and an engine housing; an electric motor having an electric motor housing; at least one storage battery coupled to the electric motor; a clutch rotatably connected to a shaft, the shaft extending from the flywheel through the electric motor; a controller configured to control the fluid pump with inputs from an operator and the fluid pump and an output of the engine and the electric motor; and an inverter coupled between the electric motor and the controller, the inverter providing at least a charging setting and a power setting; when the inverter is in the charging setting the electric motor produces power which is stored in the at least one electrical storage battery and when the inverter is in the power setting the electric motor is providing power as the output.

In some embodiments, the hybrid motor for the fluid pump may include a display for displaying the parameters of the hybrid motor conditions and having a user selectable engine feature.

In some embodiments, the hybrid motor for the fluid pump may include a skid, the skid having a base to fix the engine and the electric motor to and a fuel tank.

In some embodiments, the hybrid motor for the fluid pump may include a lifting belt for fixing the inverter to the skid.

In some embodiments, the hybrid motor for the fluid pump may include a lower section having removable trays for housing the at least one storage battery.

In some embodiments, the hybrid motor for the fluid pump may include an elastomeric coupler coupled to the electric motor housing and to the fluid pump.

In some embodiments, the hybrid motor for the fluid pump may include that when the inverter is in the charging setting power is stored until the battery is fully charged and when the inverter is in the power setting power is added from the electric motor.

In some embodiments, the hybrid motor for the fluid pump may include an engine having a flywheel and an engine housing; an electric motor having an electric motor housing; a controller configured to control the fluid pump; and an inverter coupled to the electric motor, the inverter providing at least a charging setting and a power setting; where the controller controls the fluid pump, an output of the engine, and the electric motor.

In some embodiments, the hybrid motor for the fluid pump may include at least one storage battery coupled to the electric motor and a clutch rotatably connected to a shaft, the shaft extending from the flywheel through the electric motor.

In some embodiments, the hybrid motor for the fluid pump may include that when the inverter is in the charging setting the electric motor produces power which is stored in the at least one storage battery and when the inverter is in the power setting the electric motor is providing power as the output.

In some embodiments, the hybrid motor for the fluid pump may include a display for displaying the parameters of the hybrid motor conditions and having a user selectable engine feature.

In some embodiments, the hybrid motor for the fluid pump may include a skid below the engine housing and the electric motor housing, the skid having a base to fix the engine housing and the electric motor housing to, and a fuel tank.

In some embodiments, the hybrid motor for the fluid pump may include the skid having a lower section having removable trays for housing the at least one storage battery.

In some embodiments, the hybrid motor for the fluid pump may include that when the inverter is in the charging setting power is stored until the battery is fully charged and when the inverter is in the power setting power is added from the electric motor.

In some embodiments, the hybrid motor for the fluid pump may include an inverter in communication with an alternator, at least one battery, and a controller, the inverter providing at least a charging setting and a power setting; the controller in communication with an engine, the controller configured to control the fluid pump with inputs from an operator and the fluid pump and an output of the engine and the alternator; that when the inverter is in the charging setting the alternator produces power which is stored in the at least one storage battery and when the inverter is in the power setting the electric motor is providing power as the output.

In some embodiments, the hybrid motor for the fluid pump may include the engine has a flywheel and an engine housing; the at least one battery is coupled to an electric motor; and a clutch rotatably connected to a shaft, the shaft extending from the flywheel through the electric motor.

In some embodiments, the hybrid motor for the fluid pump may include a display for displaying the parameters of the hybrid motor conditions and having a user selectable engine feature.

In some embodiments, the hybrid motor for the fluid pump may include a skid, the skid having a base to fix the engine and the electric motor to, and a fuel tank.

In some embodiments, the hybrid motor for the fluid pump may include a lifting belt for fixing the inverter to the skid.

In some embodiments, the hybrid motor for the fluid pump may include a lower section of the skid having removable trays for housing the at least one storage battery.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

Other features, advantages and details of the present invention will emerge on reading the following description of several embodiments of the invention given by way of illustration and not being limiting, said description being made with reference to the appended drawings.

FIG. 1 is an isometric view of an embodiment of the hybrid motor with an exemplary skid;

FIG. 2 is a side cut away view of an embodiment of the hybrid motor;

FIG. 3 is a system schematic of an embodiment of the hybrid motor;

FIG. 4 is a table of exemplary hybrid motor element mode specifications; and

FIG. 5 is a graph of the power versus speed comparison of exemplary motors.

### DETAILED DESCRIPTION OF THE DISCLOSURE

For purposes of the description hereinafter, spatial orientation terms, as used, shall relate to the referenced embodiment as it is oriented in the accompanying drawings, figures, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

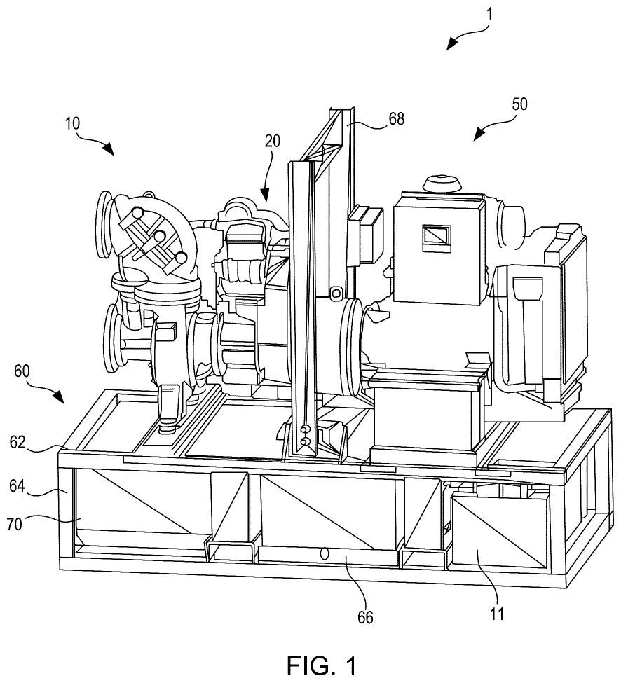

The present disclosure is directed to, in general, a hybrid motor and, in particular, to a diesel-electric hybrid motor, controller, battery, and display having a skid. Certain preferred and non-limiting aspects of the components of the hybrid motor and skid are illustrated in FIGS. 1-5.

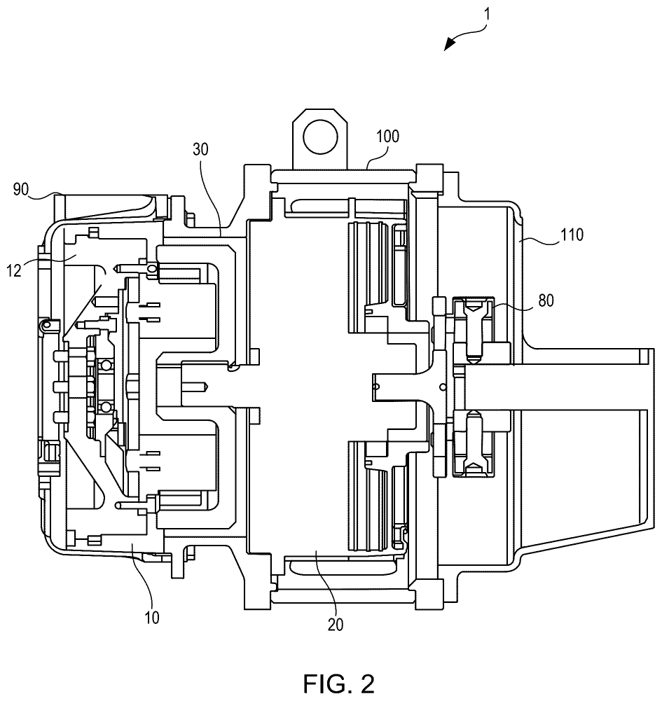

FIG. 1 is an isometric view of a hybrid motor 1 according to an exemplary embodiment of the present invention. As shown in FIG. 1, a hybrid motor 1 according to an exemplary embodiment of the present invention may include a combustion engine 10, for example fueled by diesel, an electric motor 20, a clutch 30 (shown in FIG. 2) that selectively connects the engine 10 and the motor 20, an inverter, a differential gear device, a battery, a hybrid starter and generator, and controller 50 configured to start the motor 1 or generate power based on an output of the motor 1. The hybrid motor 1 may also include other components, such as, a power inverter assembly, radiator, intake manifold, control system enclosure, shock absorber towers, and other components, such as various filters, fuel injection system, master cylinder assembly, water pump, electronic ignition housing, etc. The components of the hybrid motor 1 may be held within or on a skid 60. The skid 60 may also include a location for the combustion engine fuel tank 11 and an additional location for the battery 70 for the combustion engine 10.

As shown in FIG. 1, the skid 60, according to an exemplary embodiment of the present invention, may be configured such that the hybrid motor 1 rests upon a base 62 of the skid 60. The skid 60 may have a lower section 64 for housing batteries 70. The batteries 70 may rest on trays 66 which may slide out for easier access. A lifting belt 68 may extend upward from the base 62 of the skid 60. The skid 60 may include fastening locations to fasten the components of the hybrid motor 1 to the skid 60.

The batteries 70 are arranged in a pack and are not limited to a specific voltage, and based on its configuration and arrangement of cells, may provide a different voltage, with the specific combustion engine 10 and electric motor 20 selected for efficient operation in the voltage range provided by the batteries 70 arranged in a pack. The batteries 70 may store power in any form, but preferably store energy in an electrical form. The batteries 70 arranged in a pack may also provide electrical power to the hybrid motor 1 for electronic ignition and spark generation, controller operation, clutch controller operation, accessory operation, and any other component of the hybrid motor, and may power the pump. Preferably, but not limited to, the multiple batteries 70 are used with a 3-8 kW capacity rated at 50-150 amps continuous with a 40-60 volt nominal voltage. The batteries 70 preferably include an on-board management system with a peak power of 10-20 kW for 5-15 seconds. The batteries 70 preferably operate from at least −30 degrees F. to 170 degrees F. Further, in one embodiment, the batteries 70 may have 10-30 kW hours of battery storage. The batteries 70 may operate at 1500-2100 RPM for 45-75 minutes. While these features of the batteries 70 may be preferable, the batteries 70 may still include ranges outside of these features.

FIG. 2 is a side cut away view of the hybrid motor 1 according to an exemplary embodiment of the present invention. The combustion engine flywheel 12, the electric motor 20, and an elastomeric coupler 80 each have a housing 90, 100, 110 configured to house each individual component. The housing 90, 100, 110 may be shaped to ergonomically form around the individual components or as a whole.

The combustion engine 10 combusts a fuel to generate torque which may be used to provide energy that simultaneously charges the batteries 70 and provides energy to the portable pump. Various engines such as a gasoline engine, a diesel engine, and a liquefied petroleum gas engine and electric motor (LPI engine) may be used as the engine 10, but preferably a diesel engine is used. The combustion engine 10 preferably includes the specifications of a diesel engine rated for 30-38 kW and a displacement of 1-3 L. The electric motor 20 converts electric power to generate torque. Any electric motor 20 may be used, but preferably the motor 20 is designed for 10V-100V. Preferably, but not limited to, the electric motor 20 is rated for a minimum of: 5-10 kW at 600-1000 RPM, 13-19 kW at 1500-2100 RPM, and 15-25 kW at 2500-3100 RPM. Preferably the electric motor 20 has a peak power rating of: 9-15 kW at 600-1000 RPM, 25-35 kW at 1500-2100 RPM, and 40-50 kW at 2500-3100 RPM. While these features of the electric motor 20 may be preferable, electric motor 20 may still include ranges outside of these features.

Further shown is a torque distribution assembly, also referred to interchangeably as the clutch 30, which is operatively coupled to the engine flywheel 12. In a preferred embodiment of the invention, a centrifugal mechanical clutch is used. While the features of the centrifugal mechanical clutch may be preferable, the clutch 30 may include features of any type of clutch.

The flywheel 12 receives rotational power from a crankshaft of the combustion engine 10. The torque distribution assembly or clutch 30 is responsible for distributing the torque generated by the combustion engine 10 according to different mechanical modes.

In connection with torque transmission of the hybrid motor 1, torque generated from the combustion engine 10 and/or the electric motor 20 may be selectively transmitted to an input shaft of the centrifugal pump via an elastomeric coupler to produce an output. While an elastomeric coupler is preferred, other types of couplers may be used. The produced output, being the torque generated from the hybrid motor 1, is then used at a pump end or stored in an energy storage device such as a battery. The battery may be configured to supply electricity back to the motor 1 in a set mode and may be charged with electricity recovered through the motor 1.

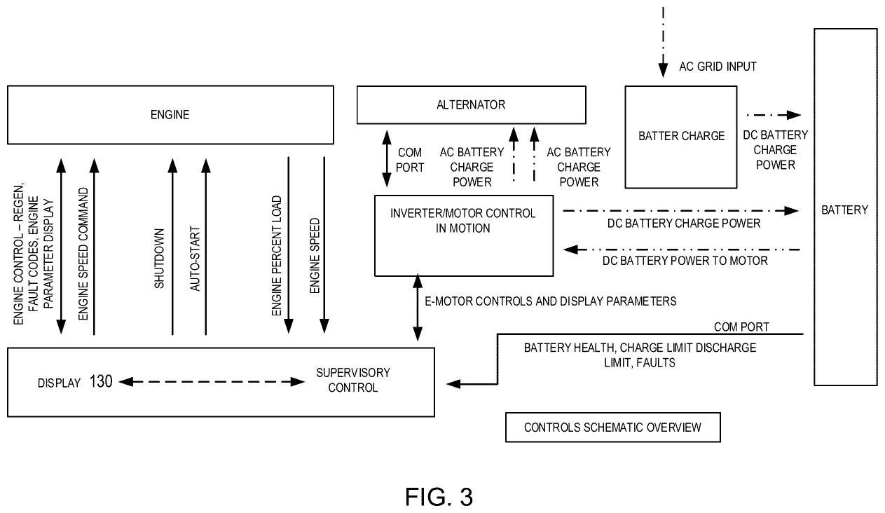

In one embodiment as shown in FIG. 3, the supervisory controller 50 communicates with the inverter, the combustion engine 10, and batteries 70. The supervisory controller 50 may be or may include one or more microprocessors or computers/computer systems, discrete components, etc. The supervisory controller 50 controls the operating mode of the hybrid motor 1 system. The operating mode of the motor 1 may determine the specific operating function of one or more components of the hybrid power system including, but not limited to, the internal-combustible engine 10, the electric motor 20, and the first inverter.

The combustion engine 10 is also operative to provide torque to the electric motor-generator 20 for charging the batteries or battery pack 70 or for providing power to the hybrid motor 1 in a specific operating mode.

The hybrid motor 1 may be set in an electric mode in which torque of the electric motor 20 is used; an engine mode in which only torque of the combustion engine 10 is used; a hybrid electric mode in which torque of the combustion engine 10 is used as main torque and torque of the electric motor 20 is used as auxiliary torque.

A user-selectable display may permit the operator to switch between a pure electric mode, a hybrid mode, and a customized operation mode. The switch may be a depressible button, knob, lever, or other control input, and may be located on the display 130. The controller 50 utilizes the state of the switch as an input operating signal to determine whether the supervisory controller 50 has selected an electric-only mode or a hybrid mode. The display parameters preferably include: motor speed, motor load, battery health, estimated minutes of run time left based on battery capacity and current load, electric motor speed, charging, and boosting. The display 130 is preferably a display system intended for mobile equipment applications. The mobile display will communicate with a similar controller that will house all of the logic and instructions to control the combustion engine and inverter and electric motor with inputs from the system parameters to control the system. The user may also select or customize specific parameters that the hybrid motor 1 may operate with, such as speed limits or not to exceed a certain battery charge amount. Per environmental conditions, different modes or parameters may be selected. For example: when the batteries 70 are depleted or operating conditions increase, the combustion engine 10 may be activated to provide energy that simultaneously charges the batteries 70 and provides energy to the portable pump; at maximum operating conditions for the pump, the combustion engine 10 and electric motor 20 will combine to provide maximum energy available to satisfy environmental pumping conditions.

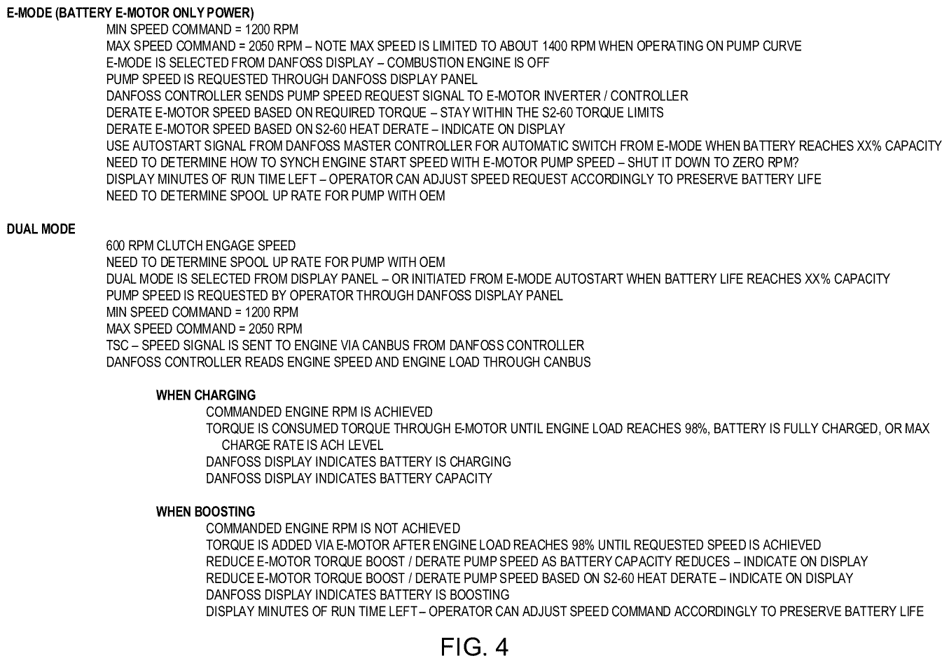

FIG. 4 is a table of exemplary hybrid motor element mode specifications. During the E-mode the electric motor 20 is the only power source. The E-mode may be selected by a user on the display 130. During the Dual mode, both the combustion engine 10 and the electric motor 20 are power sources. Dual mode may be selected by a user on the display 130. Dual mode may also include two settings such as charging mode and boosting mode. When in charging mode, torque is consumed through the electric motor 20 until the batteries 70 are charged to a desired amount. When in boosting mode, torque is created by the electric motor 20 to increase the efficiency of the hybrid motor 1. Such modes may be controlled by the supervisory control 50 and the inverter/motor control. Although not shown or listed in FIG. 4, certain environmental conditions may cause different modes or parameters to be selected. When the batteries 70 reach a certain threshold or lack a set amount of storage, the combustion engine 10 may be activated to provide energy that simultaneously charges the batteries 70 and provides energy to the portable pump. At a needed increased energy operating condition for the pump, the combustion engine 10 and electric motor 20 may combine and simultaneously operate to provide increased energy output availability to satisfy environmental pumping conditions.

In one embodiment, the hybrid mode may run a pump with the batteries 70 when operating under approximately 1100-1700 RPM. The combustion engine 10 may start running if the batteries 70 becomes less than 15-25% charged or if the operating speed exceeds 1100-1700 RPM. In this hybrid mode, the combustion engine 10 recharges the batteries 70 when under-loaded. The E-mode may consist of the batteries 70 only operating to generate power. This may have a specified run time duration, but may also be up to 45-75 minutes. All of these values are user-adjustable as application requirements demand.

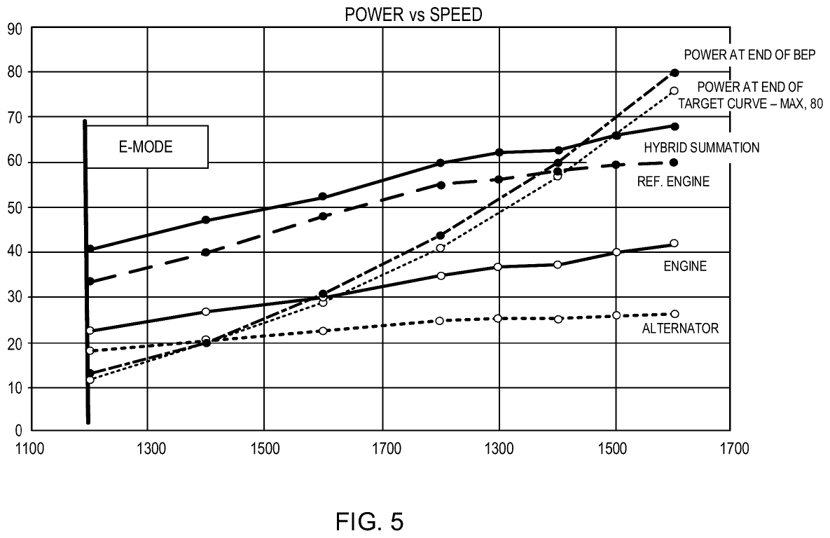

FIG. 5 shows a graph of the hybrid power system operating according to an electric-only power mode, a combustion engine-only power mode, and a hybrid summation mode at different RPMs. This graph is a related visual to the details of FIG. 4. In one implementation of the electric-only power mode, the battery pack 70 provides power to the electric motor 20 via the supervisory controller 50. The clutch 30 is not engaged such that the electric motor-generator 20 and the combustion engine 10 are not coupled. The combustion engine 10 is not powered and the electric motor 20 provides all power to operate the hybrid motor 1. The hybrid power system may operate in the electric-only mode when an operator selects the electric-only mode using the input control. The graph shows an example of the hybrid power system operating according to a combustion engine 10 only mode. The graph further shows an example of the hybrid power system operating according to a hybrid mode. The graph further shows a dual mode in the charging range and a dual mode in a boosting range.

FIG. 5 displays a graph of the load versus power comparison of exemplary motors. The reference is a similar sized displacement, 2.2 liter engine with a larger power rating of 46 kW engine that can operate the pump without additional input from a hybrid system. The hybrid system will combine the performance of the preferred 2.2 liter diesel engine rated for 34 kW with the 20 kW electric motor generator to provide the combined or the hybrid summation and are compared at different RPM speeds to show the increase in efficiency.

Advantageously, the hybrid motor 1 allows the combustion engine 10 to operate efficiently as it may be run at full capacity to charge the energy storage system in addition to driving any pumping mechanism.

What is claimed is:

1. A hybrid motor for a fluid pump, comprising:
an engine having a flywheel and an engine housing;
an electric motor having an electric motor housing;
at least one storage battery coupled to the electric motor;
a clutch rotatably connected to a shaft, the shaft extending from the flywheel through the electric motor;
a controller configured to control the fluid pump with inputs from an operator, the fluid pump, and an output of the engine and the electric motor;
an inverter coupled between the electric motor and the controller, the inverter providing at least a charging setting and a power setting; and
wherein when the inverter is in the charging setting the electric motor produces power which is stored in the at least one electrical storage battery and when the inverter is in the power setting the electric motor is providing power as the output.

2. The hybrid motor for the fluid pump of claim 1, further comprising:
a display for displaying the parameters of the hybrid motor conditions and having a user selectable engine feature.

3. The hybrid motor for the fluid pump of claim 1, further comprising:
a skid, the skid comprising a base to fix the engine and the electric motor to, and a fuel tank.

4. The hybrid motor for the fluid pump of claim 3, further comprising a lifting belt for fixing the inverter to the skid.

5. The hybrid motor for the fluid pump of claim 3, further comprising a lower section having removable trays for housing the at least one storage battery.

6. The hybrid motor for the fluid pump of claim 1, further comprising an elastomeric coupler coupled to the electric motor housing and to the fluid pump.

7. The hybrid motor for the fluid pump of claim 1, wherein when the inverter is in the charging setting power is stored until the at least one storage battery is fully charged and when the inverter is in the power setting power is added from the electric motor.

8. A hybrid motor for a fluid pump, comprising:
an engine having a flywheel and an engine housing;
an electric motor having an electric motor housing;
a controller configured to control the fluid pump;
an inverter coupled to the electric motor, the inverter providing at least a charging setting and a power setting; and
wherein the controller controls the fluid pump, an output of the engine, and the electric motor.

9. The hybrid motor for the fluid pump of claim 8, further comprising:
at least one storage battery coupled to the electric motor and a clutch rotatably connected to a shaft, the shaft extending from the flywheel through the electric motor.

10. The hybrid motor for the fluid pump of claim 8, wherein when the inverter is in the charging setting the electric motor produces power which is stored in the at least one storage battery and when the inverter is in the power setting the electric motor is providing power as the output.

11. The hybrid motor for the fluid pump of claim 10, further comprising:
a display for displaying the parameters of the hybrid motor conditions and having a user selectable engine feature.

12. The hybrid motor for the fluid pump of claim 8, further comprising:
a skid below the engine housing and the electric motor housing, the skid comprising a base to fix the engine housing and the electric motor housing to, and a fuel tank.

13. The hybrid motor for the fluid pump of claim 12, wherein the skid comprises a lower section having removable trays for housing the at least one storage battery.

14. The hybrid motor for the fluid pump of claim 10, wherein when the inverter is in the charging setting power is stored until the at least one storage battery is fully charged and when the inverter is in the power setting power is added from the electric motor.

15. A hybrid motor for a fluid pump, comprising:
an inverter in communication with an alternator, at least one storage battery, and a controller, the inverter providing at least a charging setting and a power setting;
the controller in communication with an engine, the controller configured to control the fluid pump with inputs from an operator, the fluid pump, and an output of the engine and the alternator; and
wherein when the inverter is in the charging setting the alternator produces power which is stored in the at least one storage battery and when the inverter is in the power setting an electric motor is providing power as the output.

16. The hybrid motor for the fluid pump of claim 15, wherein:
the engine has a flywheel and an engine housing;
the at least one storage battery is coupled to the electric motor; and
a clutch rotatably connected to a shaft, the shaft extending from the flywheel through the electric motor.

17. The hybrid motor for the fluid pump of claim 15, further comprising:
a display for displaying the parameters of the hybrid motor conditions and having a user selectable engine feature.

18. The hybrid motor for the fluid pump of claim 16, further comprising:
a skid, the skid comprising a base to fix the engine and the electric motor to, and a fuel tank.

19. The hybrid motor for the fluid pump of claim 18, further comprising a lifting belt for fixing the inverter to the skid.

20. The hybrid motor for the fluid pump of claim 18, further comprising a lower section of the skid having removable trays for housing the at least one storage battery.
